(19) United States
(12) Patent Application Publication
(10) Pub. No.: US 2012/0264097 A1
(43) Pub. Date: Oct. 18, 2012

(54) ANATOMICAL MODEL

(75) Inventors: Benjamin J. Newcott, Costa Mesa, CA (US); Eric D. Wichems, Tustin, CA (US); Jeffrey R. Cellini, Mission Viejo, CA (US)

(73) Assignee: ALLERGAN, INC., Irvine, CA (US)

(21) Appl. No.: 13/326,673

(22) Filed: Dec. 15, 2011

Related U.S. Application Data
(60) Provisional application No. 61/423,474, filed on Dec. 15, 2010.

(51) Int. Cl. G09B 23/28

(52) U.S. Cl. 434/267

(57) ABSTRACT

A breast torso model is provided for patient and physician education.

This application claims the benefit of, and priority to, U.S. Provisional Patent Application No. 61/423,474, filed on Dec. 15, 2010, the entire disclosure of which is incorporated herein by this specific reference.

The present invention generally relates to anatomical models and more specifically relates to a breast torso model useful for education of breast implant technique and breast implant sizing.

Deciding on breast augmentation is a difficult issue for many women which is naturally exacerbated when a woman feels she is not able to fully understand or appreciate the surgical procedure.

U.S. Pat. No. 4,323,350 to Bowden, Jr. discloses an anatomical model comprising a plurality of molded sections of uniform thickness, each of which has a flesh appearance on one side, suitable for anatomical study.

U.S. Pat. No. 6,769,286 to Biermann, et al. discloses an instrumented torso model that simulates anatomical features and measures the effect on a body caused by various types of impacts.

U.S. Pat. No. 6,669,483 to Leight, et al. discloses an instrumented breast model for training lay persons and health care providers in performing breast examinations to locate and identify masses in a breast.

U.S. Pat. No. 7,553,159 to Arnal et al. discloses a surgical training model of the abdominopelvic region of a human patient to assist in training in microsurgical techniques.

What is needed is a better anatomical model for educating patients and health care professionals about breast surgery.

### SUMMARY

Accordingly, an improved breast torso model is provided which is useful in educating patients and health care professionals regarding aspects of breast surgery, for example, revisional and augmentation surgery, for example, for the placement of the breast implant or tissue expander, sizing of the implant or tissue expander, placement of the incision, usage of other adjuvant devices during procedures, and employment of other techniques employed in breast surgery.

In some embodiments, the model includes features that approximate various anatomical landmarks.

In some embodiments, the model has a clamshell design.

In some embodiments, the model will accept implants of various sizes and dimensions in various orientations. In other words, the model can be “implanted” with various prostheses. When “implanted”, the model can approximate the result of implanting an actual patient with a device of various proportions.

In one aspect of the invention, an anatomical model is provided comprising a frame, an anatomical assembly simulating body tissue secured to the frame, and a slot in the frame for containing informational material. The frame may comprise a first portion and a second portion hingedly connected to one another and the anatomical assembly includes a breast component simulating body tissue and secured to the first portion of frame, and a muscle component secured to the second portion of the frame. The model may further include a cavity between the breast component and the muscle component capable of receiving a breast implant between the breast component and the muscle component. The muscle component may be at least partially separable from the second portion of the frame. The second portion may include a depression beneath the muscle component for receiving a breast implant between the muscle component and the depression.

Various features, advantages and aspects of the invention may be more clearly understood and appreciated with reference to the following Detailed Description and the accompanying Drawings.

### BRIEF DESCRIPTION OF THE DRAWINGS

FIG. 1 is a perspective view of a breast torso model of the present invention.

FIG. 2 is a perspective view of the model shown in FIG. 1, now showing the feature of a slidable information card.

FIG. 3 is a side view of the model shown in FIG. 1.

FIG. 4 is a rear view of the model shown in FIG. 1.

FIG. 5 is a perspective view of the model shown in FIG. 1 with a portion opened to reveal some of the internal components of the model.

FIG. 6 is a perspective view of the model shown in FIG. 1 with a portion opened to reveal some of the internal components of the model, now also showing more of the internal components.

FIG. 7 is an exploded view of the model shown in FIG. 1.

FIGS. 8 and 9 are cross section views of the model.

FIGS. 10 and 11 are cross section views of the model with an implant placed in different locations in the model.

FIG. 12 is an exploded view of a portion of the model.

### DETAILED DESCRIPTION

The present invention provides a breast torso model useful for educating patients and health care professionals about key aspect of breast surgery. These key aspects include, but are not limited to, placement of a breast implant or tissue expander, sizing of an implant or tissue expander, placement of the incision, usage of other adjuvant devices during procedures, and employment of other techniques employed in breast surgery.

The torso model includes features that approximate various anatomical landmarks. In some embodiments, the model accepts implants of various sizes and dimensions in various orientations. In some embodiments, the model has a substantially clamshell design, can be “implanted” with various prostheses. When “implanted”, the model can approximate the result of implanting an actual patient with a device of various proportions.

In one aspect of the invention, the model provides an educational tool for prospective breast reconstruction or augmentation patients.

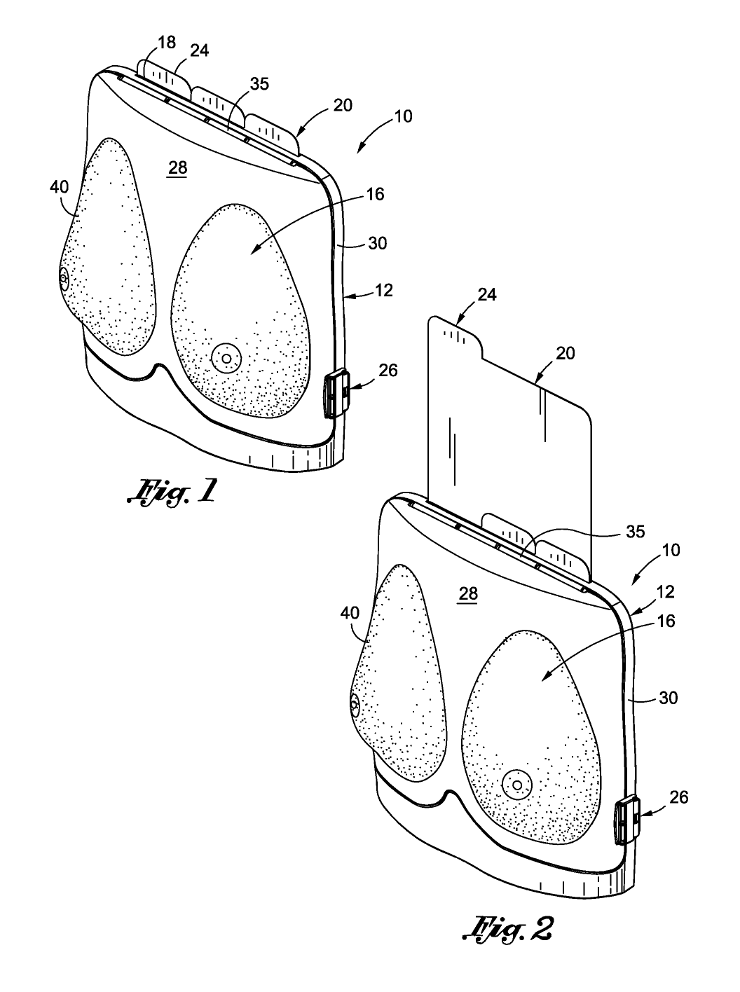

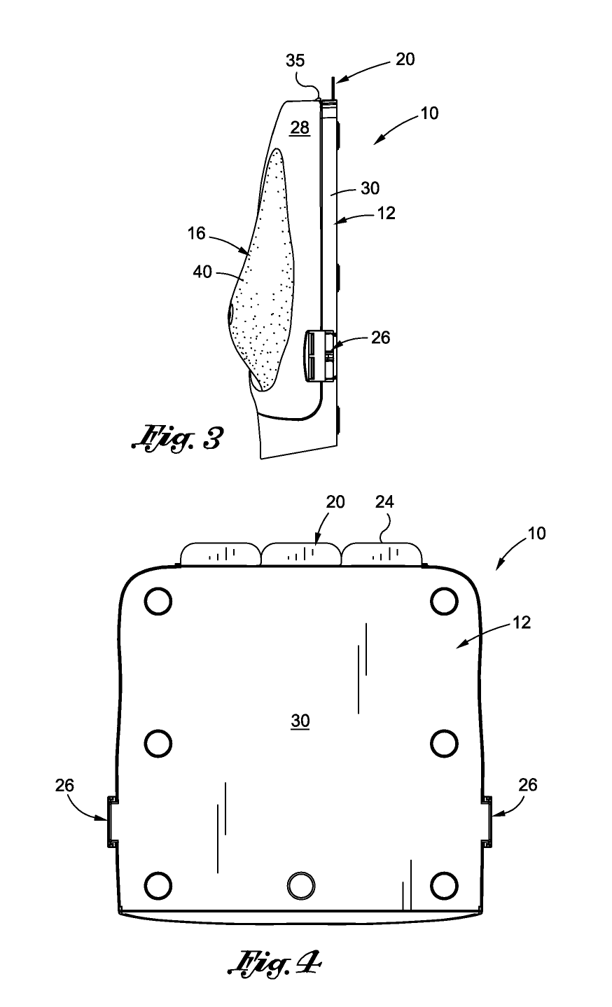

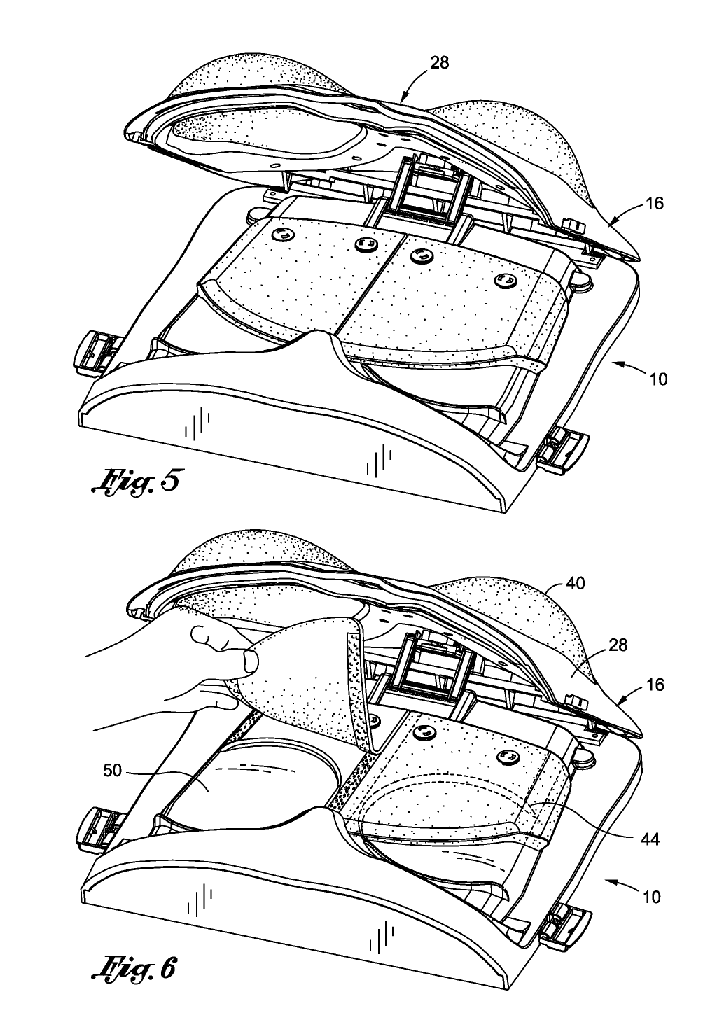

For example, turning to FIGS. 1 through 4, in an exemplary embodiment, the model 10 generally comprises a frame and an anatomical assembly 16 simulating layers of body tissue, secured to the frame 12. In the shown embodiment, the model 10 further comprises means for containing informational material, for example, and a slot 18 in the frame 12 for slidably containing informational material 20, for example, a plurality of tabbed placards 24 containing useful educational or promotional material.

Turning now to FIG. 5, the model 10 may comprise an assembly of separable anatomical features, for example, in the form of layers which imitate the anatomical features of the anterior of a human torso.

As shown in FIG. 3, the base surface 27 on the frame 12 is angled so that the model 10 will tilt slightly backward and not tip forward when in an elevated position. The model 10 can thus be displayed in an upright position.

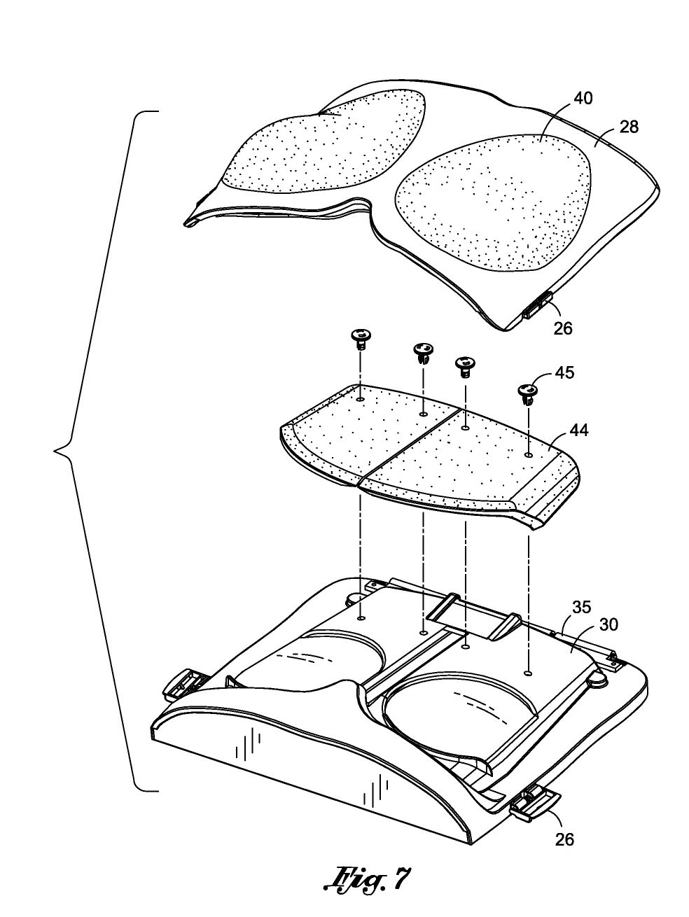

The frame 12 comprises a clamshell-like structure, which may include a first frame portion 28 and a second frame portion 30 connected by hinge 35 (shown in FIGS. 1-4) which allows opening of the model 10, as shown in FIGS. 5 and 6.

To keep the model 10 from inadvertently opening, one or more latches 36 to secure the first frame portion 28 and the second frame portion 30 in a closed position (FIGS. 1-4) may be provided as shown. Pivoting of the first frame portion 28 away from the second frame portion 30 via hinge 35 will cause separation of the anatomical assembly 16 into separately viewable, different components simulating different anatomical features of the human torso.

For example, the anatomical assembly 16 may comprise a first component 40 (breast piece 40) secured to a first frame portion 28, and a second component 42 secured to the second frame portion 30. First component 40 roughly or closely simulates the outer appearance and feel of human breasts. Second component 44 (muscle piece 44) roughly or closely simulates the appearance of the subgladular muscle.

In one embodiment, the opening of the model 10 is limited to a 40 degree angle opening.

The material of the breast piece 40 and muscle piece 44 may be created using injection molded thermoplastic rubber, or other suitable material. The flexibility of these pieces 40, 44, can be selected based on the thickness and the durometer or density of the piece. In the shown embodiment, the muscle piece 44 is about 0.25″ thick, tapering at the edges.

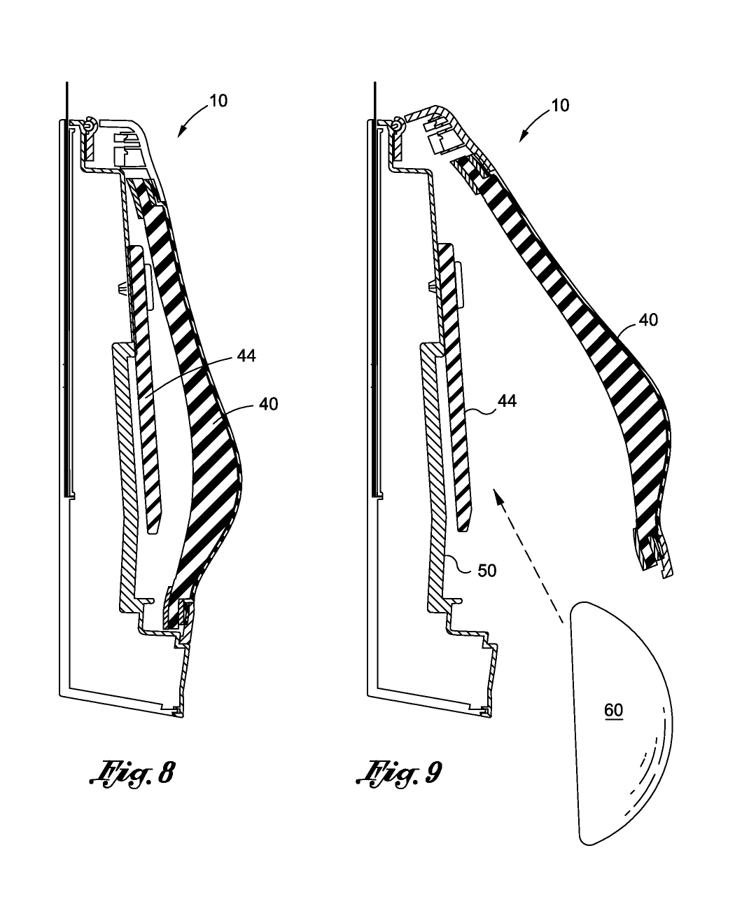

Suitable assemblage of the different components of model 10 is shown in FIG. 7. For example, rivets 45 may be used to hingeably secure muscle piece to second frame portion 30.

Turning back to FIG. 6, the muscle piece 44 may include an openable left portion 44a and an openable right portion 44b, each being able to be lifted apart from frame portion 30 as shown to receive a breast implant (not shown in FIGS. 5 and 6) in depression 50. Hook and loop fasteners 52 may be provided for removable securing muscle 44a and 44b pieces in place on the frame portion 30.

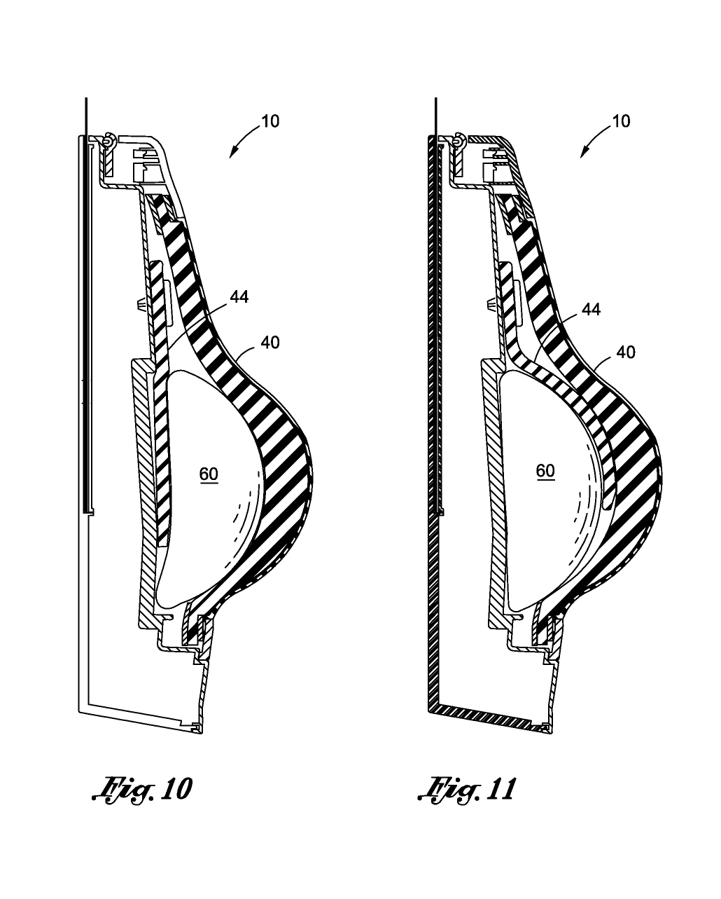

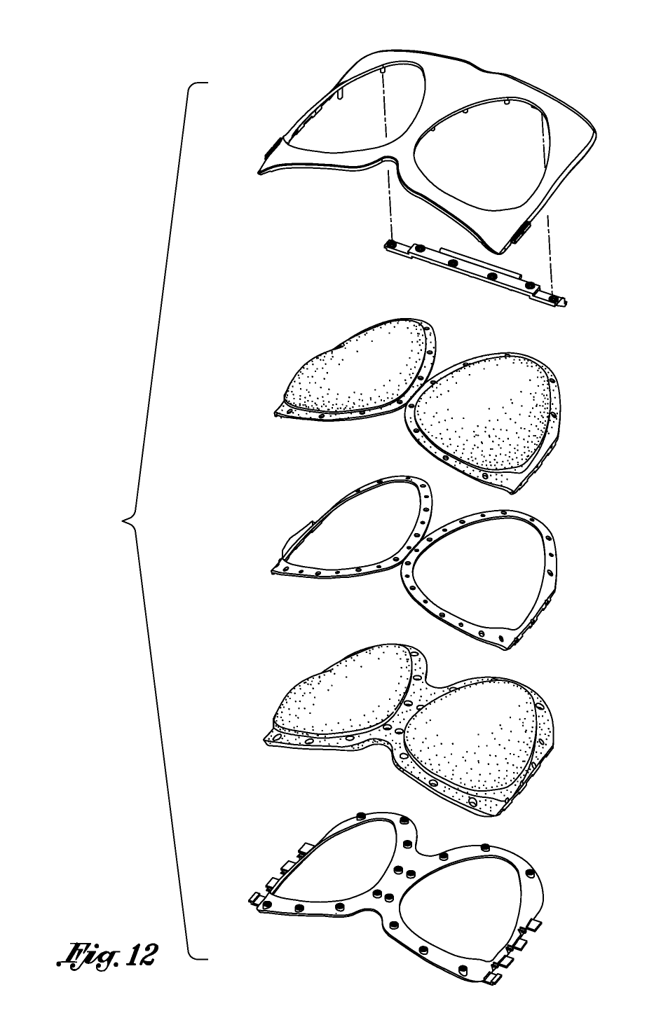

In use, a physician may demonstrate to a patient different choices of breast implant surgery. For example, turning to FIGS. 8 and 9, the physician may place an implant 60 into the model 10 by opening the frame (FIG. 9) and sliding the implant 60 into one of two different places on the model 10. For example, the implant 60 may be placed between breast piece 40 and muscle piece 44 to demonstrate subgladular placement of an implant (as shown in FIG. 10). Alternatively, the physician my place an implant beneath the muscle piece 44 (e.g. in depression 50) to demonstrate submuscular placement of an implant (as shown in FIG. 11). It can be appreciated that the model 10 can also be used to demonstrate the general appearance of an implanted breast, having different sized implants for comparison.

While this invention has been described with respect to various specific examples and embodiments, it is to be understood that the invention is not limited thereto and that it can be variously practiced within the scope of the invention.

What is claimed is:

1. An anatomical model comprising:
a frame;
an anatomical assembly simulating body tissue secured to the frame; and
a slot in the frame for containing informational material.

2. The model of claim 1 wherein the frame comprises a first portion and a second portion hingedly connected to one another.

3. The model of claim 1 wherein the anatomical assembly includes a breast component simulating body tissue and secured to the frame.

4. The model of claim 2 wherein the anatomical assembly includes a breast component simulating body tissue and secured to the first portion of the frame, and a muscle component secured to the second portion of the frame.

5. The model of claim 4 wherein the model includes a cavity between the breast component and the muscle component capable of receiving a breast implant between the breast component and the muscle component.

6. The model of claim 4 wherein the muscle component is at least partially separable from the second portion of the frame.

7. The model of claim 4 wherein the second portion includes a depression beneath the muscle component for receiving a breast implant between the muscle component and the depression.

8. The model of claim 4 wherein the muscle component is at least partially separable from the second portion of the frame and the second portion includes a depression beneath the muscle component for receiving a breast implant between the muscle component and the depression.

9. The model of claim 8 wherein the model includes a cavity between the breast component and the muscle component capable of receiving a breast implant between the breast component and the muscle component.

10. An anatomical model comprising:
a frame having a first portion and a second portion hingedly connected to one another;
a breast component simulating body tissue and secured to the first portion of the frame;
a muscle component and secured to the second portion of the frame;
a cavity between the breast component and the muscle component capable of receiving a breast implant between the breast component and the muscle component.

11. The model of claim 10 wherein the muscle component is at least partially separable from the second portion of the frame.

12. The model of claim 10 wherein the second portion includes a depression beneath the muscle component for receiving a breast implant between the muscle component and the depression.
